(19) United States
(12) Patent Application Publication
(10) Pub. No.: US 2025/0376184 A1
(43) Pub. Date: Dec. 11, 2025

(54) Method for actuating at least one system component of a system according to surroundings information generated by the system

(71) Applicant: AUDI AG, Ingolstadt (DE)

(72) Inventor: Peter SOSSALLA, Ingolstadt (DE)

(73) Assignee: AUDI AG, Ingolstadt (DE)

(21) Appl. No.: 19/230,846

(22) Filed: Jun. 6, 2025

(30) Foreign Application Priority Data
Jun. 7, 2024 (DE) 10 2024 115 995.2

(51) Int. Cl. B60W 50/14; G01C 21/34; H04W 4/46

(52) U.S. Cl. CPC B60W 50/14; G01C 21/34; H04W 4/46; B60W 2520/10; B60W 2554/20

(57) ABSTRACT

A method and system configured to actuate at least one system component of a system according to surroundings information generated by the system. Image data are captured by a capture device of the system. Upon detection of a trigger, position data of the system are annotated on the image data. Subsequently, a text description message for the image data is prepared by a visual question answering system of the system (24), so that the surroundings information is generated. At least one system component is then actuated according to the surroundings information. An actuated system component may include a warning message and/or a navigation instruction and/or providing the surroundings information as a message to at least one further system is effectuated if the further system is located at a distance to the system and/or on a trajectory corresponding at least in some sections to that of the system is traveled.

### CROSS-REFERENCE TO RELATED APPLICATIONS:

This application claims the priority benefit of German Patent Application No. 102024 115 995.2 filed on Jun. 7, 2024, which is incorporated by reference herein in its entirety.

### BACKGROUND

### 1. Field

An invention relates to a method for actuating at least one system component of a system according to surroundings information generated by the system, according to described examples.

### 2. Description of the Related Art

Sharing surroundings information is a goal of V2X, Vehicle-to-Everything communication. For this purpose, for example, a message can be transmitted from a first system to at least one further system, in particular by means of a collective perception message, to transmit the surroundings information. Obstacles or objects can be classified here by the first system and transmitted in the message as a detected obstacle or object to one or at least one further system. The actuation of a system component, such as an automatic braking system, to reduce the velocity or bring the system entirely to a standstill, can also be caused upon detection of such an obstacle.

DE 11 2018 000 899 T5 discloses a method and systems for identifying objects from a 3D point cloud and a 2D image. The method can include determining a first set of 3D proposals using Euclidean clustering on the 3D point cloud and determining a second set of 3D proposals from the 3D point cloud based on a neural 3D convolutional network. The method can include merging the first and second set of 3D proposals to determine a set of 3D candidates. The method can include projecting the first set of 3D proposals on the 2D image and determining a first set of 2D proposals using a neural 2D convolutional network. The method can include merging the projected first set of 3D proposals and the first set of 2D proposals to determine a set of 2D candidates, and then merging the set of 3D candidates and the set of 2D candidates.

EP 3 675 121 A2 discloses one or more embodiments which comprise a virtual personal assistance module executed on a virtual personal assistance system. The module of the virtual personal assistant receives first sensor data from a first sensor, which belongs to a plurality of sensors. The virtual personal assistance module analyzes the first sensor data to generate a first result. The virtual personal assistant module receives second sensor data from a second sensor from the plurality of sensors. The virtual personal assistant module analyzes the second sensor data and the first result to generate a second result. The virtual personal assistant module outputs an audio output in natural speak to the user based on the second result.

In the prior art, it is insofar disadvantageous that a classification of objects can often only be implemented for a restricted number of objects so that an information loss occurs upon generating or sharing surroundings information. Furthermore, a dependence on the objects defined in the standards in messages can have a restrictive effect. The restriction of the number of objects to be classified can have the result that the generated surroundings information is also restricted.

### SUMMARY

The invention according to described examples is based on example objects of providing a system capable of passing on surroundings information to other systems depending on the detected context or trigger.

The example objects may be achieved by the subjects of the independent claims. Advantageous refinements of the invention according to the examples may be described by the dependent claims, the following description, and the figure.

The invention according to the examples may relate to a method for actuating at least one system component of a system according to surroundings information generated by the system. The following steps may be carried out for this purpose:
capturing image data by a capture device of the system, such as a camera, and feeding or introducing the image data into the capture device,
upon detection of a predetermined trigger: annotating position data of the system on the image data, for example by using a GNSS module (GNSS—Global Navigation Satellite System) in the camera, and generating a text description message for the corresponding image data by a visual question answering system of the system, wherein surroundings information is thus generated,
according to the surroundings information: actuating the at least one system component, comprising: generating a warning message and/or a navigation instruction and/or providing the surroundings information as a message to one or at least one further system if the surrounding information is located at a predetermined distance to the system and/or on a trajectory corresponding at least in some sections to that of the system is traveled along.

The system thus detects a “trigger”, such as a vehicle or an obstacle in direct proximity to the system, thus, for example: 5 m to 500 m distance or within a predetermined radius, such as 5 m to 2 km. The detection device can thus be configured or trained to detect the corresponding triggers, for example by a CNN (Convolutional Neural Network) trained for this purpose.

The system can moreover be equipped with various sensors, such as cameras and/or radar sensors and/or lidar sensors.

“Predetermined” can mean that a trigger (to be detected) is defined beforehand.

The (first) system can cause object tracking of a detected obstacle by corresponding sensors from the prior art, and thus can estimate a trajectory of the obstacle corresponding at least in some sections, in that the system creates a prediction about its future trajectory on the basis of the surroundings information and/or a movement pattern of the detected obstacle.

The visual question answering (VQA) system can be a VQA system from the prior art. One possibility for this purpose is to make use of a combination of CNN and RNN (Recurrent Neural Network). The CNN can be used to extract visual features from the image, while the RNN, for example configured as a Long Short-Term Memory (LSTM), is used to understand the question and generate a corresponding answer.

Furthermore, the image data can be enriched using GNSS data, so that a detected trigger can be localized, at least for the time of the detection.

The VQA system or module can then generate a text description message or a text for the image data. A description of an example for this purpose is to be found below.

The image data together with the annotated GNSS data and the text description message can be viewed as a whole as an example of surroundings information. The surroundings information can be expanded in this case using further data. For example, data on traffic density and/or road closures and/or accidents and/or construction sites can be used. Another example is the use of data relating to (current) message reports, which supply information about events which could have an effect on the surroundings of the system, for example in a radius of 1 km to 100 km. Resulting therefrom, on the one hand, a system component, such as a display screen device, can be actuated which generates a warning message that, for example, a traffic jam is upcoming in the course of the current trajectory of the system. In this context, a navigation suggestion or navigation instructions can then be generated next, which describe a trajectory to drive around the event, for example the traffic jam or the obstacle. Additionally or alternatively, at least partial or complete autonomous control can also be provided to carry out longitudinal and/or lateral guidance of the system according to the navigation instructions. Furthermore, it can be provided that a system component is activated therefrom, such as an intelligent heating system, if an outside temperature below a predetermined threshold value is measured, for example below 0 to 10° C.

A (contextual) sensing of the surroundings is implemented by the invention according to the examples, wherein triggers (such as events) possibly relevant for the user are detected and controls, for example to bypass the trigger, for example by a change of the trajectory, in particular by outputting a corresponding navigation suggestion, are thus executed.

There is also the advantage here that the conflict-free driving in traffic is probably increased in that, for example, heavily traveled routes (at a current or later time) are avoided by the system.

The invention according to the examples may also include refinements, due to which additional advantages result.

One refinement provides that the system is a vehicle or bicycle or mobile robot or a camera. There is also the possibility that the system is configured as a combination of the mentioned devices (for example, vehicle and camera). Different user scenarios also result depending on the configuration since, for example, a vehicle and a bicycle where possible travel at least partially different routes. The system is therefore flexible and a versatile and/or accurate sensing of the surroundings can thus be implemented.

One refinement provides that the trigger comprises:
a query of a user of the system and/or
an obstacle which is located at a predetermined distance or range to the system and/or is located on a trajectory of the system to be traveled along and/or
predetermined sensor measurements above a predetermined threshold value and/or
reaching a predetermined zone which is stored in a navigation map of the system and/or
a time-controlled request.

The query can include a specific question of the user who wishes to know whether, for example, in the next 2 to 20 km to be traveled along according to a predetermined trajectory, an accident and/or a construction site is to be found. In this way, the possibility of active prompting of the user is implemented to obtain surroundings information rapidly without having to wait for a possible trigger in this case.

To detect an obstacle which is located at a predetermined distance to the system and/or is located on a trajectory of the system to be traveled along, it is provided, for example, that image data are continuously captured, for example by a 360° camera. For this purpose, for example, it can be set by the user what is considered to be an obstacle, so that, for example, other vehicles are not detected as an obstacle, but a bicycle and/or a passerby on the road is. It is thus possible to prevent the user from receiving warning messages and/or receiving controls prompted for objects and/or further vehicles which the user can already perceive, since the user has to remain attentive as the driver. Even if the user has, for example, possibly perceived a bicyclist riding in front of the user, the advantage results that in this way the traffic safety can be enhanced.

One example of predetermined sensor measurements above a threshold value is a measured temperature measurement below a predetermined threshold value, due to which a system component, for example configured as an intelligent heating system, is switched on to bring the interior, for example in a vehicle, to a desired or predetermined temperature. The system can be equipped with a rain sensor which, if a predetermined threshold value of the sensor data or the measured rain intensity is exceeded, triggers a warning message, such as “caution, slippery conditions”, and/or automatically effectuates a speed adjustment of the system.

The term “zone” can mean various areas, for example a 30 km/h zone and/or zone around a kindergarten and/or a school and/or a freeway. An adjustment of the driving style can take place at least partially autonomously in such zones due to the above-mentioned actuation of at least one system component. In addition, a warning message can be output to notify the driver that a slower driving style is appropriate, in particular if a kindergarten and/or a school is located in the vicinity, thus in the detected zone.

With respect to the time-controlled query, this means that, for example, every t time intervals, a query is prompted, wherein t means in particular 5 seconds to 5 minutes. The query can comprise one or more questions together with answers that are predefined or are to be provided in real time. An example in this regard can be found below.

One refinement provides that the time-controlled query is prompted depending on
a speed of the system and/or
a number and/or type of detected objects in the surroundings of the system and/or
detected surroundings.

A “time-controlled query” is a query which is automatically initiated after passage of a specific time span. This time span can be permanently predetermined.

The speed of the system can refer to the current movement speed of the system. The time-controlled query can be triggered more frequently or more rarely in this context, depending on how fast the system moves. At a higher speed, for example above 80 to 100 km/h, it can be set, for example, that queries are placed more frequently (for example, every five seconds), in order to ensure that the system always has current information and can react quickly to changes.

“Number and/or type of detected objects in the surroundings of the system” can mean that the time-controlled query can be made dependent on how many objects (e.g., obstacles and/or other vehicles and/or persons) are detected in the surroundings or in a predetermined radius, for example 500 m to 10 km, of the system and which type of objects these are (for example, fixed obstacles or moving objects). If many objects are detected, for example greater than 4 or 8, or if specific objects (such as pedestrians) are in the surroundings, the system can increase the frequency of the queries (for example, queries every five seconds), to obtain accurate and/or current information or surroundings information.

The surroundings of the system can comprise various factors, such as the type of the terrain (city and/or country and/or impassable terrain) and/or weather conditions and/or light conditions. The time-controlled query can be adapted accordingly depending on the type and condition of the surroundings. In complex and/or unsafe surroundings, it can be necessary to place queries more often (for example, every five seconds) in order to enable a conflict-free journey. This can be set accordingly in each case.

One refinement provides that the text description message is generated by the visual question answering system in that at least one of multiple predetermined questions is answered, which is linked with predetermined at least partially similar features from the captured image data, wherein the visual question answering system is trained using a data set which contains image data or features from image data, associated questions, and corresponding answers.

In an example, a trained VQA model having an accuracy of at least 70% to 90% on a validated test data set or data set is to be selected.

It can be provided that when a text description message is necessary, the image data are transferred together with at least one of five predetermined questions and corresponding answers to the VQA model, so that feedback or answers which are pre-established or to be answered in real time are provided by the VQA model.

The system can capture image data of a road, for example, on which a bicyclist is riding. The VQA module can automatically generate and answer a question such as “is there a bicyclist on the road?”. Based on this answer, the VQA module can then generate a text description message which states, for example: “A bicyclist rides on the road XY in the eastern direction.” or “a bicyclist is located within 400 m near you.”.

In that questions are placed in real time, the VQA module can react immediately to new information and update the text description message accordingly. This ensures that the generated message always corresponds to the current conditions. It is provided in this case that an answer is generated which corresponds most closely to the question according to the training data, thus the question-answer pairs on which the VQA module was trained, thus has the highest probability.

One refinement provides that the surroundings information and/or the position data additionally comprises/comprise an alignment angle and/or a speed and/or a planned trajectory or route of the system and is/are provided to one or more further systems automatically and/or by manual effectuation of the user. “Planned trajectory” means the previously defined route or path which the system is supposed to take. The alignment angle relates to the direction or position in which the system is aligned relative to the detected obstacle. By incorporating the alignment angle, for example measurable by an electronic compass and/or IMU (inertial measurement unit), the system can determine its position more accurately in relation to the surroundings. This enables precise localizing and orientation, which is advantageous in particular in applications such as navigation or robotics. The alignment angle can contribute to accurately detecting and tracking objects and/or obstacles in the surroundings, in particular if they are located in different viewing directions. Moreover, the user can deliberately pass on or send surroundings information generated by the user's system to at least one further system, for example in the immediate surroundings, in particular in a radius of 10 m to 100 km. Additionally or alternatively, it can be set that the at least one further system in the immediate surroundings automatically contains the surroundings information.

The user overall has the possibility of deliberately passing on or having passed on the surroundings information generated by his system to other systems. The user can thus supervise the data relay and ensure that only relevant information is sent to the at least one further system.

Multiple systems can cooperate and exchange surroundings information by way of the deliberate relay of surroundings information. This can improve the performance and efficiency of the respective systems which are dependent on common data, for example in the coordination of the systems, for example designed as at least partially autonomous vehicles.

Due to the possibility of sending surroundings information in real time to other systems, the receivers can immediately access updated information and react accordingly. This is important above all in dynamic surroundings in which conditions can change rapidly. The range of the relay of surroundings information can be scaled as needed, from at least one local system in the immediate vicinity up to at least one remote system, for example more than 100 km distant, thus in a larger geographic range. The system is thus flexible and adaptable to various usage scenarios.

Overall, it is thus provided that systems exchange or share their surroundings information (in the form of or by a message) with one another, in order to each obtain a comprehensive and/or accurate perception of their surroundings. The message can be present, for example, as a textual description, so that all types of surroundings information are textually described by the VQA module. Corresponding devices for preparing and receiving such messages can be taken from the prior art. The transmission of the message can take place, for example: by mobile wireless and/or Bluetooth and/or WLAN (wireless local area network).

Passing on the message, thus the surroundings information, can contribute to detecting potential hazards early and/or taking preventative measures.

One refinement provides that the provision takes place by making the message accessible via an edge cloud and/or cloud infrastructure for one or more further systems or by direct transmission thereto. The relay of surroundings information can thus take place by sharing the message with other systems via an edge cloud and/or cloud infrastructure. Additionally or alternatively, the message can be transmitted by V2V, Vehicle-to-Vehicle, directly from one system to at least one other system.

One refinement provides that the system is expanded or updated, by
a feedback system, which receives feedback from the user after carrying out the method, and/or
adding further data sets, comprising image data or features from image data, associated questions, and corresponding answers, and/or
versioning in the backend of the system and/or by receiving update data via mobile wireless and/or WLAN.

After the system has carried out the method, it can activate a feedback system which receives feedback from the user. For example, the system can display an assessment prompt to the user in order to determine the user satisfaction.

For example, the system, after it has calculated a navigation route or has output a navigation suggestion, can display a message to the user and request the user to assess the accuracy and effectiveness of the route. The feedback can then be captured and, for example, used to improve controls to be triggered, in that it is evaluated, for example manually by an expert team responsible for this purpose.

The system can be expanded or updated by adding further data sets in order to improve its performance. This can comprise image data or features from image data as well as associated questions and answers. For example, image data from various traffic situations can be linked with questions and corresponding answers to cover a broader palette of scenarios. For this purpose, it can be provided that the image data captured in the method are further processed, for example manually by the above-mentioned expert team.

Updates and improvements can be efficiently managed by the versioning in the backend of the system. This enables various versions of the system to be managed and older versions to be used if needed. This makes it easier for the system to make use of earlier statuses if, for example, problems occur in the execution of a control, which have not yet occurred in an earlier version.

The system can receive update data via mobile wireless and/or WLAN to keep its functionality and performance up-to-date. This can comprise the integration of updates and/or patches and/or new training data.

For applications or application situations which can arise in the method and are not explicitly described here, it can be provided that according to the method an error message and/or a request to input user feedback is output and/or a standard setting and/or a predetermined initial status is set.

The invention according to the examples also includes the control device for the system. The control device can comprise a data processing device or a processor unit (processor circuit), which is configured to carry out a method according to the examples of the invention. The processor unit can comprise for this purpose at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit), or an NPU (Neural Processing Unit) can each be used as a microprocessor. Furthermore, the processor unit can comprise program code configured to carry out a method according to the examples of the invention upon execution by the processor unit. The program code can be stored in a data memory of the processor unit. The processor unit can be based, for example, on at least one circuit board and/or on at least one SoC (System on Chip).

The system according to the examples of the invention can be configured, for example, as a motor vehicle or as an automobile, for example as a passenger vehicle or truck, or as a bus or motorcycle.

As a further solution, the invention according to the examples also comprises a computer-readable storage medium, comprising program code which, when it is executed by the control device or a computer or a computer network, causes it to carry out an a method according to the examples of the invention. The storage medium can be at least partially provided as a nonvolatile data memory (for example, as a flash memory and/or as an SSD—solid-state drive) and/or at least partially as a volatile data memory (for example, as a RAM—random-access memory). The storage medium can be arranged in the computer or computer network. However, the storage medium can also be operated, for example, as a so-called app store server and/or cloud server on the Internet. A processor circuit having, for example, at least one microprocessor can be provided by the computer or computer network. The program code can be provided as binary code and/or as assembler code and/or as source code of a programming language (for example, C) and/or as program script (for example, Python).

The invention according to the examples also comprises the combinations of the features of the described examples. The invention according to the examples thus also comprises implementations which each comprise a combination of the features of several of the described examples, if the examples were not described as mutually exclusive.

### BRIEF DESCRIPTION OF DRAWINGS

Examples of the invention are described hereinafter with reference to the figure in which:

FIG. 1 shows a schematic representation of a method according to an example of the invention.

### DESCRIPTION

The examples explained hereinafter are examples of the invention. In the examples, the described components of the examples each represent individual features to be considered independently of one another, which each also refine the examples independently of one another. Therefore, the disclosure is also to comprise combinations of the features of the examples other than those shown. Furthermore, the described examples can also be supplemented by further ones of the above-described features of the examples of the invention.

In the figure, identical reference signs each identify functionally-identical elements.

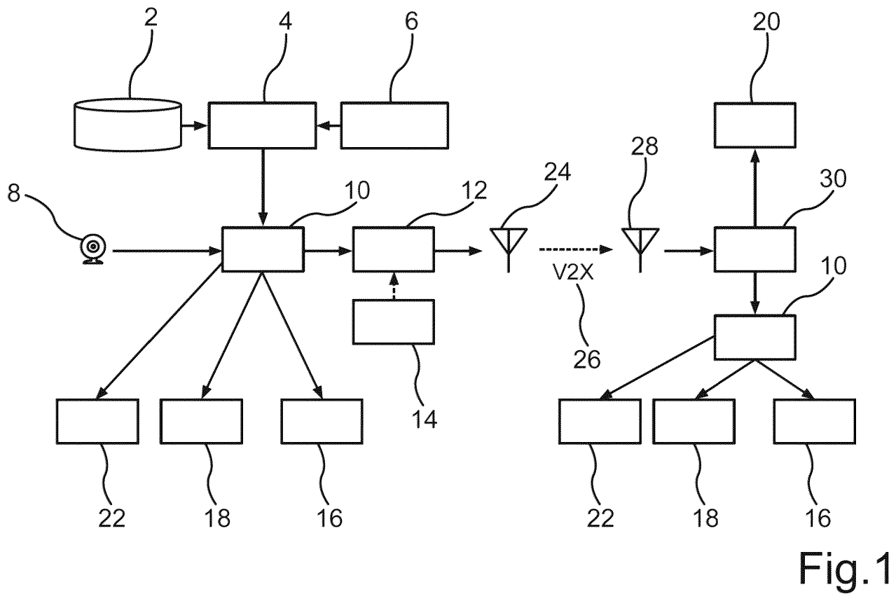

FIG. 1 illustrates a schematic representation of an example. A data set 2, a question selection 4, a trigger 6, a capture device 8, a VQA module 10, surroundings information 12, position data 14, a warning message 16, a navigation suggestion 18, a message provider 20, a system component 22, a system 24, a message 26, further systems 28, and processing of the message 30 are shown.

Initially, as shown in FIG. 1, image data can be captured by a capture device 8 of the system 24 and fed therein. Upon detection of a trigger 6, position data 14 of the system 24 can be annotated on the image data. Subsequently, a text description message for the corresponding image data can be prepared by a visual question answering system or VQA module 10 of the system 24, wherein surroundings information 12 is generated. At least one system component 22, such as an intelligent heating system, can then be actuated according to the surroundings information 12. For this purpose, it can be provided that a warning message 16 and/or a navigation instruction and/or the provision of the surroundings information 12 as a message 26, symbolically represented in this case as V2X, Vehicle-to-Everything communication, to (one or more) further systems 28 is effectuated if they are located at a predetermined distance to the system 24 and/or on a trajectory corresponding at least in some sections to that of the system 24 is traveled along.

For example, from the data set 2, a selection of N, wherein N is a number greater than 1, questions from the data set 2 can be used according to a detected trigger 6. The associated answer can be taken from the questions, so that a text description is generated for the captured image data. Alternatively, the questions used can be applied to the image data so that the VQA module 10 generates a probably new or not yet existing text description.

The processing of the message 30 by a further system 28 can include that it is enriched with surroundings information 12. This means that the surroundings information 12 can be enriched with further position data 14 and/or sensor data in general.

Overall, the examples show how it is possible to provide a method and system 24 for querying, capturing, and sharing surroundings information by a VQA module 10 and a distribution via a message 26, in particular by V2X communication.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

### LIST OF REFERENCE SIGNS

2 data set
4 question selection
6 trigger
8 capture device
10 VQA module
12 surroundings information
14 position data
16 warning message
18 navigation suggestion
20 provision of the message
22 system component
24 system
26 message
28 further systems
30 processing of the message

1. A method of actuating at least one system component of a system according to surroundings information generated by the system, comprising:
executing, by a processing device, a process including,
capturing image data by a capture device of the system and feeding the image data into the capture device,
upon detection of a trigger, annotating position data of the system on the image data, and
generating a text description message for the image data by a visual question answering system of the system, so that the surroundings information based on surroundings of the system is generated,
actuating, according to the surroundings information, the at least one system component, the actuating including at least one actuation from among actuations including:
generating a warning message,
generating a navigation instruction, or
providing the surroundings information as a message to at least one further system if the at least one further system is located at a distance to the system and/or on a trajectory corresponding at least in some sections to a trajectory the system is traveling along.

2. The method according to claim 1, wherein the system is a vehicle or bicycle or mobile robot or a camera.

3. The method according to claim 1, wherein the trigger comprises at least one trigger from among triggers including:
a query of a user of the system,
an obstacle, which is located at a distance to the system and/or is located on a trajectory of the system to be traveled,
a sensor measurement above a threshold value,
reaching a zone stored in a navigation map of the system, or
a time-controlled query.

4. The method according to claim 3, wherein the time-controlled query is prompted depending on
a speed of the system,
a number and/or type of detected objects in the surroundings of the system, and/or
detection of the surroundings.

5. The method according to claim 1, wherein
the text description message is generated by the visual question answering system, in that at least one of multiple questions is answered, which is linked with at least partially similar features from the image data captured, and
the visual question answering system is trained using a data set, which contains image data or features from image data, associated questions, and corresponding answers.

6. The method according to claim 1, wherein the surroundings information and/or the position data additionally comprise at least one information among information on an alignment angle, speed, or a planned trajectory of the system, and the at least one information is provided automatically and/or manually by a user to the at least one further system.

7. The method according to claim 1, further comprising making the text description message accessible via an edge cloud and/or cloud infrastructure for the at least one further system or by direct transmission thereto.

8. The method according to claim 1, wherein a functionality of the system is expandable by at least one function from among functions including:
providing feedback from a user after carrying out the method to a feedback system;
adding further data sets to a data set used to train the visual question answering system, the further data sets comprising image data or features from image data, associated questions, and corresponding answers; or
versioning in a backend of the system and/or by receiving update data via mobile wireless and/or WLAN, Wireless Local Area Network.

9. A system, comprising:
a control device, which comprises a processor configured to execute program instructions which, when executed by the processor, cause the processor to carry out a method including,
capturing image data by a capture device of the system and feeding the image data into the capture device,
upon detection of a trigger, annotating position data of the system (24) on the image data, and
generating a text description message for the image data by a visual question answering system of the system, so that surroundings information based on surroundings of the system is generated,
actuating, according to the surroundings information, at least one system component of the system, the actuating including at least one actuation from among actuations including:
generating a warning message,
generating a navigation instruction, or
providing the surroundings information as a message to at least one further system if the at least one further system is located at a distance to the system and/or on a trajectory corresponding at least in some sections to a trajectory the system is traveling along.

10. A motor vehicle, having the system according to claim 9.
